(19) United States
(12) Patent Application Publication
(10) Pub. No.: US 2022/0385229 A1
(43) Pub. Date: Dec. 1, 2022

(54) RV AWNING SYSTEMS AND RELATED METHODS

(71) Applicant: LIPPERT COMPONENTS MANUFACTURING, INC., Elkhart, IN (US)

(72) Inventor: Francesco CONSADORI, San Clemente, CA (US)

(21) Appl. No.: 17/825,429

(22) Filed: May 26, 2022

Related U.S. Application Data
(60) Provisional application No. 63/194,765, filed on May 28, 2021.

(51) Int. Cl. H02S 30/10; E04H 15/06; B60P 3/34; B60R 16/033; H02S 10/40; H02S 40/38; H02J 7/35

(52) U.S. Cl. CPC H02S 30/10; E04H 15/06; B60P 3/343; B60R 16/033; H02S 10/40; H02S 40/38; H02J 7/35

(57) ABSTRACT

An energized mounting bracket includes a bracket body with one or more cavities and a charge controller and one or more rechargeable batteries located in the one or more cavities. One or more solar panels can be mounted directly to the bracket body or mounted to a housing of an awning unit and the awning unit coupled to the mounting bracket. The one or more solar panels, the one or more rechargeable batteries, and the charge controller can be wired together to enable charging of the rechargeable batteries with the one or more solar panels. Power from the rechargeable batteries can power a motor mounted with the awning unit and optionally power DC outlets.

### CROSS-REFERENCES TO RELATED APPLICATIONS

This application claims the benefit of U.S. Provisional Patent Application No. 63/194,765, filed May 28, 2021, the entire content of which is herein incorporated by reference.

### FIELD OF ART

The present disclosure is generally related to recreational vehicle (RV) awning systems and related methods and, more particularly, to solar powered RV awning systems and related methods.

### BACKGROUND

A recreational vehicle (RV) is literally a home on wheels. It has all the basic amenities of a home and provides the owner with the benefit of mobility. A typical RV is equipped with a full functioning kitchen, bathroom, electrical power, heating, air conditioning, and a bedroom, or at least a bed. Power is typically supplied by an onboard generator or by plugging the RV to a power source at a campsite or at a house.

Large solar panels have been employed in recent years to supply RVs with renewable energy. When employed, they are typically mounted on the RV rooftop, between the two side edges and are wired to charge the onboard battery banks. More efficient and better use of solar power for RVs remain elusive.

### SUMMARY

An aspect of the described embodiments includes a method for forming a mounting bracket, the method comprising forming a bracket body with one or more cavities, placing a charge controller and one or more rechargeable batteries into the one or more cavities to form an energized mounting bracket.

The method can further comprise attaching the energized mounting bracket to an awning unit to form an energized awning system.

The method can further comprise mounting one or more solar panels to the mounting bracket or to a housing of the awning unit.

The method can further comprise attaching the energized awning system to a side surface of an RV or on an RV rooftop.

A further aspect of the described embodiments includes a method for forming an energized mounting bracket, the method comprising receiving an extruded mounting bracket with one or more cavities, and placing a charge controller and one or more rechargeable batteries into the one or more cavities.

The method can further comprise mounting one or more solar panels directly to the mounting bracket.

The method can further comprise attaching the energized mounting bracket to an awning unit and mounting one or more solar panels directly to a housing of the awning unit.

The method can further comprise wiring the charge controller, the one or more batteries, and the one or more solar panels to charge the one or more rechargeable batteries and powering a motor in an awning unit with power from the one or more rechargeable batteries.

The method can further comprise wiring one or more DC outlets or sockets with power from the one or more rechargeable batteries.

A still further aspect of the described embodiments includes an energized mounting bracket comprising a bracket body having one or more cavities and a charge controller and one or more rechargeable batteries located in the one or more cavities.

A still yet further aspect of the described embodiments includes an energized awning system comprising a mounting bracket attached to a housing of an awning unit, wherein the mounting bracket includes a bracket body having one or more cavities and a charge controller and one or more rechargeable batteries located in the one or more cavities.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a schematic diagram depicting an awning unit wired to a solar power system for operating a motor on the awning unit with rechargeable batteries.

FIG. 2 is a side perspective view of a mounting bracket usable to mount an awning unit to an RV.

FIG. 3 is a rear side perspective view of the mounting bracket of FIG. 2 coupled to an awning unit.

FIG. 4 is a front side perspective view of the mounting bracket of FIG. 2 coupled to an awning unit.

FIG. 5 is a side perspective view of an alternative mounting bracket usable to mount an awning unit to an RV.

FIG. 6 is a front side perspective view of the mounting bracket of FIG. 5 coupled to an awning unit.

FIG. 7 is a bottom side perspective view of the mounting bracket of FIG. 5 coupled to an awning unit.

FIG. 8 is a top side perspective view of the mounting bracket of FIG. 5 coupled to an awning unit and showing a plurality of solar panels.

### DETAILED DESCRIPTION

The detailed description set forth below in connection with the appended drawings is intended as a description of the presently preferred embodiments of RV awning systems and mounting brackets provided in accordance with aspects of the present devices, systems, and methods and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

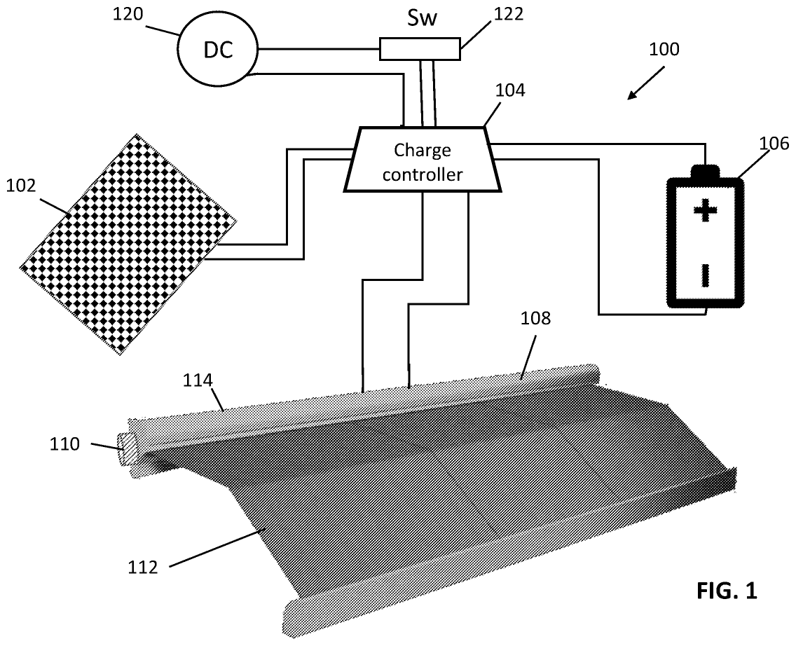

FIG. 1 is a schematic diagram depicting an RV awning system 100 provided in accordance with aspects of the described embodiments, which can be roof-mounted or side-mounted on an RV, as further discussed below. In an example, the system 100 comprises a solar panel 102, preferably of sufficient number and/or cells to generate the desired power, a DC solar charge controller or control circuit 104, a rechargeable battery 106, and a DC load 108, which can be an awning unit having a DC motor 110 for driving linkage arms to move the awning fabric or sheet 112 into or out of the awning housing 114. The various components are wired to the DC charge controller 104, which can have wireless or wired I/O ports for receiving user instructions, such as to open or close the awning 108. Power from the rechargeable battery 106 may also be wired to a DC outlet or socket 120 located inside the RV or on the RV exterior. A switch 122 is preferably located between the DC socket 120 and the charge controller 104 for energizing or de-energizing the socket 120.

Exemplary RV awning units are commercially available. The solar cells, batteries, and charge controller can be sourced from existing commercial or wholesale suppliers provided they fit within the mounting configuration of the RV awning system 100 or mounting brackets of the described embodiments, as further discussed below.

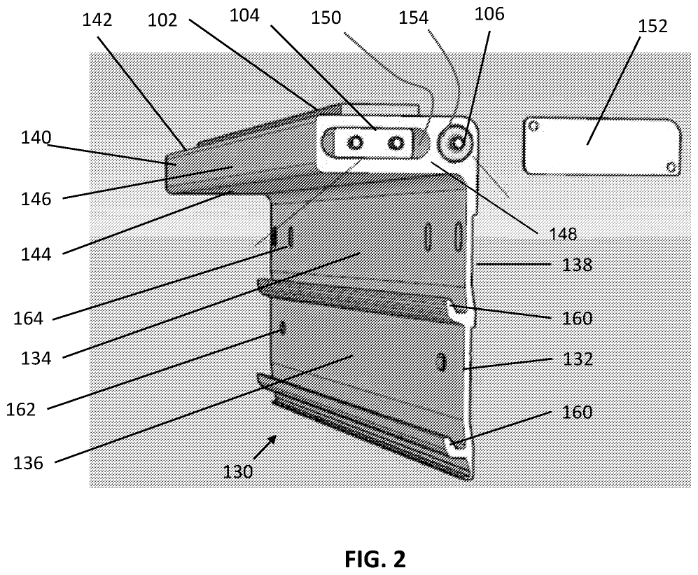

With reference now to FIG. 2, a mounting bracket 130 provided in accordance with aspects of the described embodiments is shown, which is configured to receive, couple, or connect to an awning unit to mount the awning unit to an RV. The awning unit can be similar to the awning unit 108 of FIG. 1 or other commercially available awning units. As shown, the mounting bracket 130 comprises a main body or bracket body 132 comprising a first panel section 134 and a second panel section 140. The mounting bracket 130 can be extruded from aluminum and optionally can be machined to final dimensions.

In an example, the first panel section 134 comprises a generally planar section having an awning-side surface 136 and an opposed RV-side surface 138. The awning-side surface 136 is configured to directly face or contact an awning unit when the awning unit is mounted to the mounting bracket 130. The RV-side surface 138 is configured to directly face the RV or contact the RV when the mounting bracket 130 is mounted to the RV so as to mount the awning unit to the RV, as further discussed below.

The second panel section 140 extends at an angle to the first panel section 134. In an example, the second panel section 140 has an upper surface 142 and a lower surface 144, and at least the upper surface 142, the lower surface 144, or both the upper and lower surfaces are at approximately right angle to a surface section of the awning-side surface 136, the RV-side surface 138, or both the awning-side surface 136 and the RV-side surface 138. The first panel section 134 and the second panel section 140 define a receiving space for receiving an awning unit. For example, when assembled, the awning unit is flanked on at least two sides by the mounting bracket, such as along an upper side by the second panel section 140 and along a lateral side by the first panel section 134.

The second panel section 140 has a thickness dimension measured between the upper surface 142 and a lower surface 144. That is, the second panel section 140 has a body 148 with a thickness defined between the upper and lower surfaces. A first cavity 150 is provided in the body 148 between the upper and lower surfaces. The first cavity 150 is sized and shaped to accommodate the charge controller 104. The first cavity 150 can extend the entire length of the second panel section 140 or any length less provided the first cavity 150 can accommodate the charge controller 104. Preferably, the first cavity is sized to fully receive the charge controller 104 so that a panel cover 152 can then mount over the opening of the first cavity to enclose the first cavity.

A second cavity 154 can be provided with the second panel section 140. The second cavity 154 can be located next to the first cavity 150 and can be sized and shaped to receive one or more rechargeable batteries 106. The rechargeable batteries 106 can be lithium-ion batteries packaged in a cylindrical configuration for fitting into the second cavity 154. The panel cover 152 can mount over the opening of the second cavity 154 in addition the opening of the first cavity 150 to enclose the two cavities. Optionally, two separate panel covers are provided, one for mounting over the first opening and another for mounting over the second opening of the two cavities. The second cavity 154 can extend the entire length of the second panel section 140 or any length less provided the second cavity can accommodate the one or more rechargeable batteries 106. In an alternative embodiment, the first and second cavities can be combined in a single cavity that accommodates both the charge controller 104 and the one or more rechargeable batteries 106. A baffle or a divider can be located in the single cavity to separate the charge controller from the one or more batteries.

Two spaced apart hook tabs 160 may be provided on the awning-side surface 136 of the first panel section 134. Each hook tab 160 can have a structure that extends radially of the surface 136 and can have a hook at an end thereof for engaging a corresponding channel on the awning unit to mount the awning unit. In the example shown, each hook tab 160 has a continuous body or structure that runs the length of the first panel section 134. In other embodiments, each hook tab 160 can have gaps and can embody a plurality of sections. The two hook tabs 160 can be generally parallel to each another. The spacing of the two hook tabs 160 should coincide with the spacing of corresponding receiving channels on the awning unit so that they mate during assembly.

A plurality of mounting holes 162, 164 can be provided with the first panel section 134. The mounting holes 162, 164 can be through holes and are configured to receive mounting screws that can be used to fasten the mounting bracket 130 to a side of an RV. Slotted through holes 164 can be provided to facilitate drilling and/or screwing efforts.

In an example, the length of the mounting bracket 130 is about the same or slightly less than the length of an awning unit that is mounted to the mounting bracket. Alternatively, the length of the mounting bracket 130 can be substantially shorter than the length of the awning unit, such as being less than half of the length of the awning unit, so that two or more mounting brackets 130 can be used to mount the awning unit to an RV. In yet another example, only one such mounting bracket 130 is used for powering the awning unit and the additional different mounting brackets, without the charge controller and batteries, are used to support the awning unit to then mount the awning unit to an RV.

The solar panel 102 can be mounted atop the upper surface 142 of the second panel section 140. The solar panel 102 can have a plurality of solar cells. Preferably, the solar panel 102 can have a footprint or size that is the same or smaller than the surface area of the upper surface 142. As shown, the solar panel 102 has ends and sides that are recessed from the ends and sides of the second panel section 140. Alternatively, the solar panel 102 can extend beyond one or more edges of the second panel section 140. In some examples, two or more solar panels can be mounted atop the upper surface 142 of the second panel section 140.

Although not shown, ports, slots, and/or channels may be provided for wiring the various components to electrically connect them. If the ports, slots, and/or channels terminate on the exterior of the second panel section 140 or exterior of the mounting bracket, then they could be sealed or waterproofed. In some examples, the panel cover 152 can have a pocket or pockets to accommodate cables that may pass outwardly of the cavities to enable connection of the components.

The mounting bracket 130 with the charge controller 104 and one or more rechargeable batteries 106 can be referred to as an energized mounting bracket 131. The charge controller 104 and the one or more rechargeable batteries 106 can be located in a cavity formed in the body of the mounting bracket as described above or can be located in separate cavities formed in the body of the mounting bracket.

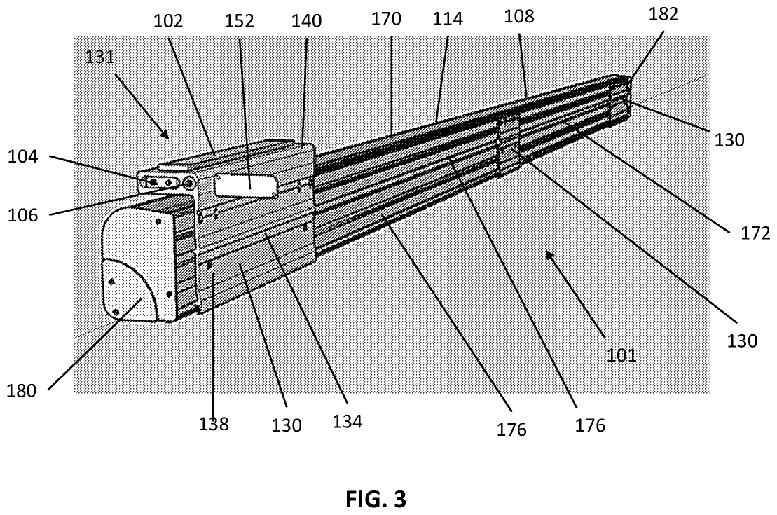

FIG. 3 is a rear perspective view of the mounting bracket 130 of FIG. 2 assembled to an awning unit 108. As shown, the housing 114 of the awning unit 108 has a plurality of sides, including a top side 170 and a rear side 172. The rear side 172 is configured to directly face the awning side surface 136 (FIG. 2) of the mounting bracket 130 and is provided with a plurality of channels 176, which in one embodiment comprises two or more channels, such as four, five or six channels. The channels 176 are spaced from one another and arranged to mate with the two hook tabs 160 on the first panel section 134 of the mounting bracket 130. Each channel can have a lip so that when the channels 176 are mated to the hook tabs 160 (FIG. 2), they provide physical engagements. When incorporating more than two channels 176 with the rear side 172 of the housing 114, they provide means for adjusting the relative height of the housing relative to the lower surface 144 of the second panel section 140 by selectively engaging the desired pair of channels with the hook tabs on the mounting bracket.

The mounting bracket 130 can be an energized mounting bracket 131 and has a charge controller 104, and one or more batteries 106. Additionally, one or more solar panels 102 can be mounted on the upper surface of the energized mounting bracket 131. The energized mounting bracket 131 can be mounted closer to the first end 180 of the housing 114 than the second end 182 of the housing. The first end 180 can be the end with connection ports or terminals for wiring the power source located in the mounting bracket 130 to the motor of the awning unit 108. Optionally, the mounting bracket 130 can be located further away from the connection ports or terminals of the awning unit, and connections can be completed via longer cables or wires. Depending on where the mounting bracket 130 is positioned relative to the housing 114 of the awning unit, at least one additional mounting bracket can be coupled to the housing 114 to support the housing when mounting the awning unit to the RV. In some examples, the additional mounting brackets can be a second energized mounting bracket 131 and wherein power from the second energized mounting bracket 131 can power DC sockets located inside the RV and/or provide power to exterior sockets located externally of the RV interior. In still yet other examples, one or more mounting brackets 130 without the power unit, i.e., without the solar panel, charge controller, and one or more rechargeable batteries, can be used with the energized mounting bracket 131 to support the awning unit.

As shown, two non-energized mounting brackets 130 may be provided in addition to the energized mounting bracket 131 for supporting the awning unit 108 when mounting the awning unit to an RV, such as to a side of the RV. The two mounting brackets 130, one near the second end 182 of the housing and the other proximate the center location, are similar to the first panel section 134 of the mounting bracket of FIG. 2. The end and the middle mounting brackets 130 can each have a second panel section 140 or the second panel section can be omitted. The combination awning unit and one or more energized mounting brackets may be referred to as an energized awning system 101.

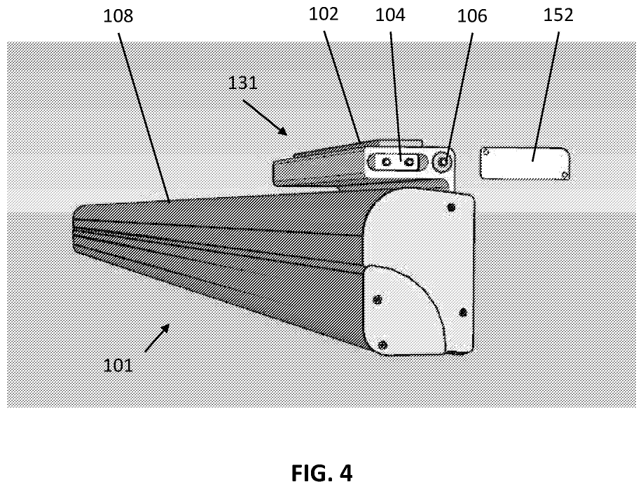

FIG. 4 is a front perspective view of FIG. 3.

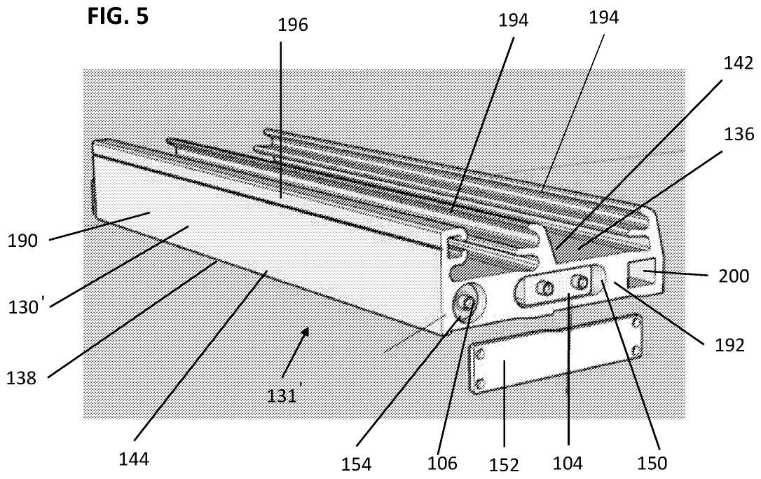

FIG. 5 is a perspective view of another mounting bracket 130′ provided in accordance with further aspects of the described embodiments. The modified mounting bracket 130′ is configured for RV rooftop mounting. As shown, the mounting bracket 130′ comprises a main body or bracket body 190 comprising a base 192 and a plurality of hook tabs 194, 196 extending outwardly from the base. The mounting bracket 130′ may be made from extruded aluminum.

The base 192 has a thickness located between an awning-side surface 136 and an opposed RV-side surface 138. The awning-side surface 136 is configured to directly face or contact an awning unit when the awning unit is mounted to the mounting bracket 130′. The RV-side surface 138 is configured to directly face the RV or contact the RV when the mounting bracket 130′ is mounted to the RV so as to mount the awning unit to the RV, as further discussed below. In the present embodiment, the RV-side surface 138 is configured to be placed on the RV rooftop and be mounted atop thereof.

In an example, the awning-side surface 136 of the base represents an upper surface 142 and the RV-side surface 138 represents a lower surface 144. The base 192 has a thickness dimension measured between the upper surface 142 and the lower surface 144. A first cavity 150 is provided in the body 190 between the upper and lower surfaces. The first cavity 150 is sized and shaped to accommodate a charge controller 104. The first cavity 150 can extend the entire length of the base 192 or any length less provided the first cavity 150 can accommodate the charge controller 104. Preferably, the first cavity is sized to fully receive the charge controller 104 so that a panel cover 152 can then mount over the opening of the first cavity 150.

A second cavity 154 can be provided in the base 192. The second cavity 154 can be located next to the first cavity 150 and can be sized and shaped to receive one or more rechargeable batteries 106. The rechargeable batteries 106 can be lithium-ion batteries packaged in a cylindrical configuration for fitting into the second cavity 154. The panel cover 152 can mount over the opening of the second cavity 154 in addition the opening of the first cavity 150. Optionally, two separate panel covers can be provided, one for mounting over the opening of the first cavity 150 and another for mounting over the opening of the second cavity 154. The second cavity 154 can extend the entire length of the base 192 or any length less provided the second cavity 154 can accommodate the one or more rechargeable batteries 106. In an alternative embodiment, the first and second cavities can be combined in a single cavity that accommodates both the charge controller 104 and the one or more rechargeable batteries 106. A baffle or a dividing wall can be provided to keep the charge controller 104 and batteries 106 apart.

The mounting bracket 130′ having a charge controller 104 and one or more rechargeable batteries 106 may be referred to as an energized mounting bracket 131′. The charge controller 104 and the one or more rechargeable batteries 106 can be located in a cavity formed in the body of the mounting bracket or can be located in separate cavities formed in the body of the mounting bracket.

An optional third cavity 200 can be provided in the base 192. The third cavity 200 may have a different cross-sectional shape than the first and second cavities and may be provided as a spare cavity, to receive additional batteries, to run cables, or to provide venting. Optionally, the third cavity 200 can be omitted. When incorporated, the same panel cover 152 can cover all three openings to the three cavities.

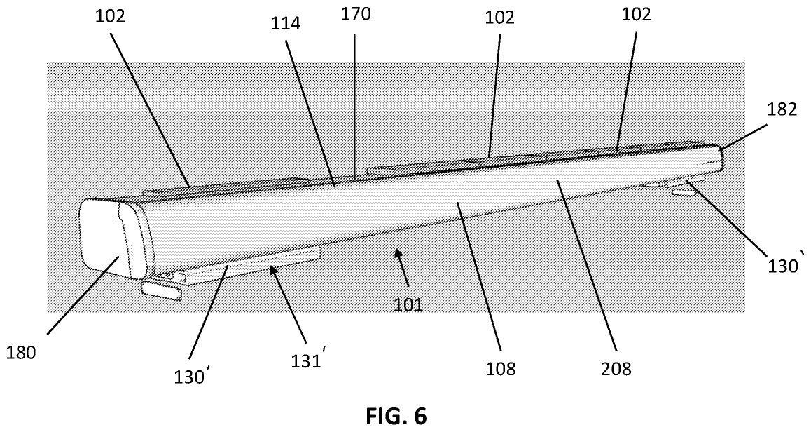

The plurality of hook tabs 194, 196 are configured to mate with channels or slots provided with the housing of an awning unit, as shown with reference to FIG. 6. In an example, two end hook tabs can have knurls or teeth that face inwardly towards a central part of the upper surface 142. The third hook tab can face or be oriented to either of the two end hook tabs. The hook tabs are sized, shaped, and arranged to mate with corresponding channels or slots on the housing of the awning unit. The knurls or teeth on the hook tabs are configured to catch corresponding lips or knurls on the channels of the housing to prevent vertical separation of the housing from the mounting bracket 130′, by allowing the knurls to physically engage.

FIG. 6 is a side perspective view of an awning unit 108 mounted or coupled to two mounting brackets 130′, 130′ of FIG. 5, both of which can be energized mounting brackets 131′, 131′. As shown, the two mounting brackets 130′, 130′ are mounted adjacent the two ends 180, 182 of the housing 114. For example, the three hook tabs 194, 196 (FIG. 5) can engage corresponding channels on the housing 114 of the awning unit 108 to couple the two mounting brackets to the awning unit. In other examples, more than two mounting brackets may be coupled to the housing of the awning unit to mount the housing to an RV. The combination awning unit and one or more energized mounting brackets may be referred to as an energized awning system 101.

One or more solar panels 102 may be mounted to the housing 114. For example, the one or more solar panels 102 may be mounted to the upper surface 170 of the housing. Alternatively, one or more solar panels 102 may be mounted to a side surface 208 of the housing 114. In an example, at least two solar panels 102 are mounted atop the upper surface 170 of the housing. Each solar panel 102 of the two solar panels can then be wired to a charge controller 104 located inside the mounting bracket of the nearest bracket. In exemplary embodiments, more than two solar panels 102 are mounted on top of the upper surface 170 of the awning unit to provide additional charging power to the charge controllers 104 to charge the batteries 106. The power provided by the rechargeable batteries 106 can be wired to one or more DC sockets to provide DC power, in addition to powering the motor located with, in or on the housing of the awning unit.

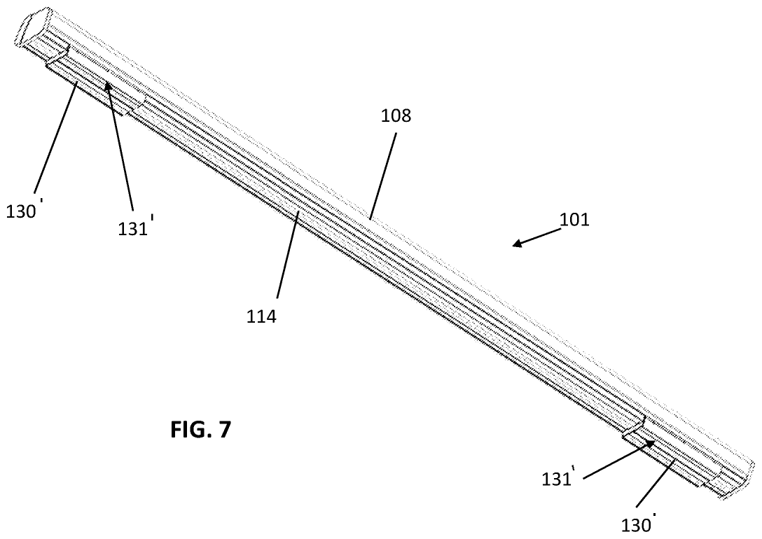

FIG. 7 is a bottom perspective view of the awning unit and mounting brackets of FIG. 6.

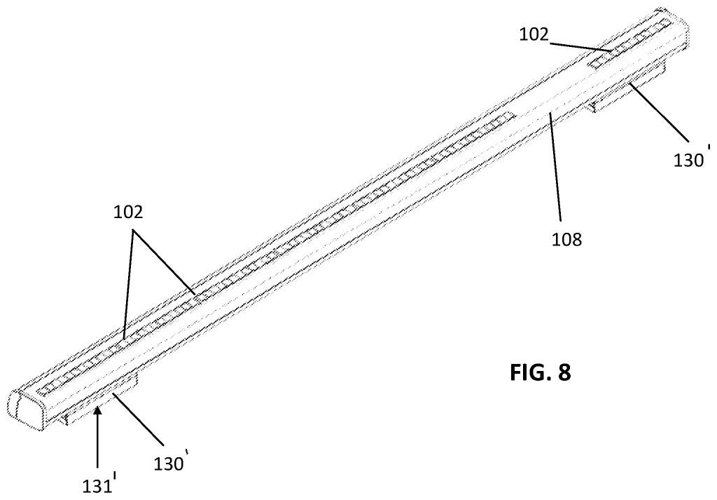

FIG. 8 is a top perspective view of the awning unit and mounting brackets of FIG. 6.

Methods of making and of using energized mounting brackets and solar panels and coupling the energized mounting brackets with awning units for mounting the awning units along upper side surfaces of RVs or on RV rooftops and components thereof are within the scope of the described embodiments.

An aspect of the described embodiments includes a method for forming a mounting bracket, the method comprising forming a bracket body with one or more cavities, placing a charge controller and one or more rechargeable batteries into the one or more cavities to form an energized mounting bracket. A method of the described embodiments can include attaching the energized mounting bracket to an awning unit. A method of the described embodiments can include attaching the combination awning unit and energized mounting bracket to a side surface of an RV or on an RV rooftop.

A still further aspect of the described embodiments includes mounting one or more solar panels directly to the mounting bracket or directly to the housing of the awning unit. The method can further include wiring the various components to charge the one or more rechargeable batteries and powering a motor in the awning unit with power from the one or more rechargeable batteries. The method can still include wiring one or more DC outlets or sockets with power from the one or more rechargeable batteries.

A still yet further aspect of the described embodiments includes mounting an awning unit using a mounting bracket to a side surface of an RV, which is angled from an RV rooftop, mounting one or more solar panels to charge one or more rechargeable batteries located in a cavity formed with the mounting bracket, and wherein the one or more solar panels are mounted laterally from a plane defined by the side surface of the RV and laterally away from the rooftop.

Although limited embodiments of energized mounting brackets and energized awning systems and their components have been specifically described and illustrated herein, many modifications and variations will be apparent to those skilled in the art. Accordingly, it is to be understood that the energized mounting brackets and energized awning system and their components constructed according to principles of the disclosed device, system, and method may be embodied other than as specifically described herein. The disclosure is also defined in the following claims.

1. A method for forming a mounting bracket, the method comprising forming a bracket body with one or more cavities, and placing a charge controller and one or more rechargeable batteries into the one or more cavities to form an energized mounting bracket.

2. The method of claim 1, further comprising attaching the energized mounting bracket to an awning unit to form an energized awning system.

3. The method of claim 2, further comprising mounting one or more solar panels to the mounting bracket or to a housing of the awning unit.

4. The method of claim 3, further comprising attaching the energized awning system to a side surface of an RV or on an RV rooftop.

5. The method of claim 1, wherein the mounting bracket is formed by extrusion.

6. The method of claim 5, further comprising attaching the energized mounting bracket to an awning unit, and mounting one or more solar panels directly to a housing of the awning unit.

7. The method of claim 6, further comprising wiring the charge controller, the one or more rechargeable batteries and the one or more solar panels to charge the one or more rechargeable batteries, and powering a motor in the awning unit with power from the one or more rechargeable batteries.

8. The method of claim 7, further comprising wiring one or more DC outlets or sockets with power from the one or more rechargeable batteries.

9. An energized mounting bracket comprising a bracket body having one or more cavities and a charge controller and one or more rechargeable batteries located in the one or more cavities.

10. The energized mounting bracket of claim 9 attached to a housing of an awning unit.

11. The energized mounting bracket of claim 9, further comprising:
a first panel section with an awning side surface and an RV side surface; and
a second panel section coupled with and extending at an angle relative to the first panel section, the second panel section including an upper surface and a lower surface defining a body with a thickness dimension, wherein the one or more cavities are formed in the body.

12. The energized mounting bracket of claim 11, wherein at least the lower surface is at approximately a right angle to the awning side surface of the first panel section such that the first panel section and the second panel section define a receiving space for an awning unit.

13. The energized mounting bracket of claim 11, wherein the one or more cavities comprise a first cavity in the body, and wherein the charge controller is disposed in the first cavity.

14. The energized mounting bracket of claim 13, wherein the one or more cavities comprise a second cavity, and wherein the one or more rechargeable batteries are disposed in the second cavity.

15. The energized mounting bracket of claim 11, further comprising two spaced apart hook tabs positioned on the awning side surface of the first panel section, each of the hook tabs having an extension that extends radially of the awning side surface and including a hook at an end thereof.

16. The energized mounting bracket of claim 11, further comprising a solar panel mounted atop the upper surface of the second panel section.

17. The energized mounting bracket of claim 9, wherein the bracket body includes a base supporting a plurality of hook tabs extending outwardly from the base, the base having an awning side surface and an RV side surface, wherein the one or more cavities are formed between the awning side surface and the RV side surface.

18. The energized mounting bracket of claim 17, further comprising an awning unit including channels with which the hook tabs are configured to mate.
